(19) United States
(12) Patent Application Publication
(10) Pub. No.: US 2024/0169263 A1
(43) Pub. Date: May 23, 2024

(54) METHOD FOR OPERATING A MACHINE LEARNING SYSTEM AND A CORRESPONDING DATA PROCESSING SYSTEM

(71) Applicant: NEC Laboratories Europe GmbH, Heidelberg (DE)

(72) Inventors: Guerkan SOLMAZ, Heidelberg (DE); Flavio CIRILLO, Heidelberg (DE)

(21) Appl. No.: 18/283,040

(22) PCT Filed: Oct. 5, 2021
(86) PCT No.: PCT/EP2021/077378

§ 371 Date: Sep. 20, 2023

(30) Foreign Application Priority Data
Apr. 1, 2021 (EP) 21166681.3

(51) Int. Cl. G06N 20/00

(52) U.S. Cl. CPC G06N 20/00

(57) ABSTRACT

A method for operating a machine learning (ML) system by means of a data processing system is provided. Original data points of a data set are labeled by the data processing system. The method provides the data set and a set of labeling functions for the original data points, applies the labeling functions to the original data points for providing a corresponding output of the labeling functions, the output comprising labeled data points and labeling function outputs corresponding to each data point. The method processes at least a part of the output for learning correlations and/or similarities between labeled data points and original data points, and predicts and/or generates labels for abstains or abstain cases of labeling function outputs under consideration of data point correlations and/or similarities.

### CROSS REFERENCE TO RELATED APPLICATIONS

This application is a U.S. National Phase application under 35 U.S.C. § 371 of International Application No. PCT/EP2021/077378, filed on Oct. 5, 2021, and claims benefit to European Patent Application No. EP 21166681.3, filed on Apr. 1, 2021. The International Application was published in English on Oct. 6, 2022 as WO 2022/207131 A1 under PCT Article 21(2).

### FIELD

The present invention relates to a method for operating a machine learning, MIL, system by means of a data processing system, wherein original data points of a data set are labeled by said data processing system.

Further, the present invention relates to a data processing system, preferably for carrying out the method for operating a machine learning, ML, system, wherein original data points of a data set are labeled by said data processing system.

### BACKGROUND

Corresponding prior art documents are listed as follows:
[1] Ratner, Alexander, et al. “Snorkel: Rapid training data creation with weak supervision.” Proceedings of the VLDB Endowment. International Conference on Very Large Data Bases. Vol. 11. No. 3. NIH Public Access, 2017.
[2] Varma, Paroma, and Christopher Ré. “Snuba: automating weak supervision to label training data.” Proceedings of the VLDB Endowment. International Conference on Very Large Data Bases. Vol. 12. No. 3. NIH Public Access, 2018.
[3] Anonymous, Uncertainty Based Active Learning Strategy for Interactive Weakly Supervised Learning through Data Programming, https://openreview.net/pdf?id=TU3CIDXYYQM
[4] Ratner, Alexander, et al. “Data programming: Creating large training sets, quickly.” Advances in neural information processing systems 29 (2016): 3567.

Further prior art document “Asterisk: Generating large training data sets with Automatic Active Supervision, May 2020, Mona Nashaat, Aindrela Ghosh, James Miller, Shaikh Quader”, discloses about Asterisk, an end-to-end framework to generate high-quality, large-scale labeled datasets. The system, first, automatically generates heuristics to assign initial labels. Then, the framework applies a novel data-driven active learning process to enhance the labelling quality. An algorithm that learns the selection policy by accommodating the modeled accuracies of the heuristics, along with the outcome of the generative model. Finally, the system employs the output of the active learning process to enhance the quality of the labels.

Further, KR 102177568 B1 discloses a method of performing semi-supervised reinforcement learning using both labeled data and unlabeled data, and an apparatus using the same.

Supervised machine learning has proven to be very powerful and effective for solving many classification problems. However it is very costly to train it since it requires a big amount of labeled data. For an accurate classifier weeks or even months are spent to annotate each data point of a large dataset. In highly specialized scenarios, such as healthcare and industrial production, domain experts are the only entitled to label the data. Thus the costs might become very high.

In the past few years, a new approach, namely dataprogramming, see [4], is proposed to significantly reduce the time for dataset preparation. In this approach, a domain expert, instead of labeling each data point, writes heuristics, each annotating a subset of the whole dataset with an accuracy that is expected to be at least better than a random annotator (labeler).

FIG. 1 shows the general concept of the existing machine learning systems with data programming approach. In this concept, a knowledge base contains a set of heuristic functions called labeling functions, LFs. The LFs can be written by domain experts, can be pretrained ML, models, can be taken from knowledge sources such as data ontologies. Each LF labels a subset of the unlabeled dataset with accuracy assumed to be better than a random annotator. The labeled subsets from the heuristics are not disjoint and the labels from different subsets for the same data point might be agreeing or conflicting. The outcome of the LFs is a matrix M where each row refers to a data point and each column refers to outputs of a particular LF. Values of the matrix are either a class of the classification problem or abstain, the LF abstains from giving a label for such data points. Discordant values might appear in each row, wherein two or more LFs give two different labels. FIG. 1 illustrates the matrix M for a binary classification problem with labels only 1 or 0, or −1 for abstains or abstain cases. Some embodiments in different classification tasks may have more than two classes represented in different ways.

In data programming, the matrix with the labels are passed to a generative model that choose for each row a single label. If a row presents only abstains or abstain cases, the generative model keeps abstain, i.e., no label. The outcome of the generative model is a vector of labels. This vector is combined with the unlabeled dataset in order to have a training dataset composed of a data point and a label, therefore each data point of the dataset to which does not correspond a label generated by the generative model is discarded. At this point, a discriminative end-model—such as an artificial neural network—is trained using the subset of the unlabeled dataset with data points with the generated labels. The discriminative model can be able to make a prediction for any given new data point with a certain confidence, even though the data point does not fall into the input range of the LFs. Thus, the discriminative model is assumed to be able to generalize for a larger sets of data.

The data programming approach allows the gathered knowledge from domain experts in a smarter way through heuristics rather than have each data points repetitively annotated.

Data programming, see [1], has been designed and successfully applied to problems where it is easy to write noisy labeling functions since the unlabeled data is easy to understand for humans, e.g. natural language processing problems. However, for sensor-based systems in internet-of-things, IoT, applications, where data points are huge vectors of numbers such as in industrial scenarios or healthcare, writing many heuristics, where each heuristic has an acceptable level of accuracy, is not a trivial task. Writing some initial easy heuristics is simple but having heuristics to cover many corner cases is still a burden. Further, simple heuristics might cover only a very small portion of the unlabeled dataset. This can be designated as a small coverage problem.

Some other solutions in the state of the art to minimize the effort of domain experts to create labelling functions include: automatic generation of labelling functions to be chosen by the domain expert, see [2], proposing a selected subset of unlabeled data points to be covered by a LF that the domain expert needs to write, see [3], proposing a selected subset of data points with conflicting labels to be annotated. This invention enhances these solutions to reduce the time spent by the domain experts for training a classifier. The main difference of the invention from these approaches is that the system does not require any additional effort for labeling data, annotating data, writing additional new labeling functions, selecting applicable labeling functions, or any other type of manual user involvement. In other words, the system enhances the existing data programming without any additional development burden or assumption of available labeled datasets, e.g., gold dataset. Furthermore, this invention can be used in combination with the mentioned state-of-the-art solutions.

In weak supervision ML approaches based on programmatic labeling of dataset through heuristics, such as data programming, writing many heuristics with acceptable level of accuracy and coverage is not a trivial task, especially in sensor-based scenarios, and health scenarios. Thus, it is a clear problem to reduce the human efforts on coding the human knowledge into heuristics and, at the same time, to achieve good performance of ML system, such as accuracy, precision and recall.

### SUMMARY

In an embodiment, the present disclosure provides a method for operating a machine learning (ML) system by means of a data processing system, wherein original data points of a data set are labeled by the data processing system, the method comprising: providing the data set and a set of labeling functions for the original data points; applying the labeling functions to the original data points for providing a corresponding output of the labeling functions, the output comprising labeled data points and labeling function outputs corresponding to each data point; processing at least a part of the output for learning correlations and/or similarities between labeled data points and original data points; and predicting and/or generating labels for abstains or abstain cases of labeling function outputs under consideration of data point correlations and/or similarities.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows in a diagram an existing system to train a classifier using data programming;

FIG. 2 shows in a diagram existing data programming and its limitations in terms of lack of good generalization and limitation of the data used by the generative model;

FIG. 3 shows in a diagram a simple illustration of an embodiment of the proposed invention with a new machine learning system design that takes the unlabeled—raw—data features into account early on in the machine learning pipeline, wherein the new design is called “generative machine learning for data programming”;

FIG. 4 shows in a diagram an embodiment of the proposed data processing system or machine learning system with a labeling function reinforcer component;

FIG. 5 shows in a diagram an embodiment of a gravitation approach for RLF where pairwise distances between data points are computed and reinforced labeling is applied based on the distances, where each abstains gravitates toward the labels from a given LF;

FIG. 6 shows in a diagram an embodiment of a clustering approach or clustering-based approach for RLF where data points are clustered and reinforced labeling is applied based on cluster similarities; and

FIG. 7 shows in a diagram an application of an embodiment of this invention to an IoT use case.

### DETAILED DESCRIPTION

In accordance with an embodiment, the present invention improves and further develops a method for operating a machine learning system and a corresponding data processing system for providing an efficient and performant method and system by simple means.

In accordance with another embodiment, the present invention provides a method for operating a machine learning, MIL, system by means of a data processing system, wherein original data points of a data set are labeled by said data processing system, comprising the following steps:
providing the data set and a set of labeling functions for the original data points;
applying the labeling functions to the original data points for providing a corresponding output of the labeling functions, the output comprising labeled data points and labeling function outputs corresponding to each data point;
processing at least a part of the output for learning correlations and/or similarities between labeled data points and original data points; and
predicting and/or generating labels for abstains or abstain cases of labeling function outputs under consideration of data point correlations and/or similarities.

An abstain or abstain case refers to a case where a labeling function does not produce classification output for a data point.

Further, in accordance with another embodiment, the present invention provides a data processing system, preferably for carrying out the method for operating a machine learning, MIL, system, wherein original data points of a data set are labeled by said data processing system, comprising:
providing means for providing the data set and a set of labeling functions for the original data points;
applying means for applying the labeling functions to the original data points for providing a corresponding output of the labeling functions, the output comprising labeled data points and labeling function outputs corresponding to each data point;
processing means for processing at least a part of the output for learning correlations and/or similarities between labeled data points and original data points; and
predicting and/or generating means for predicting and/or generating labels for abstains or abstain cases of labeling function outputs under consideration of data point correlations and/or similarities.

According to the invention it has been recognized that it is possible to provide a very efficient and performant method and system by processing the output of the labeling functions in a suitable way. It has been further recognized that such a suitable processing comprises processing at least a part of the output for learning correlations and/or similarities between labeled data points and original data points. Such original data points can include raw unlabeled data features. The part of the output can comprise only labeled data points. However, depending on the individual situation and for covering as much information as possible the whole output can be processed for learning the correlations and/or similarities. Under consideration of said learned correlations and/or similarities or generally under consideration of data point correlations and/or similarities labels for abstains or abstain cases of labeling function outputs and/or not labeled or partially labeled data points can be predicted and/or generated in a simple way for increasing the number of labels resulting in higher efficiency and performance of the method and system.

Thus, on the basis of the invention an efficient and performant method and system are provided by simple means.

According to an embodiment of the invention the data set and the set of labeling functions can be provided in a knowledge base. This provides simple, controllable and reliable access to the data set and the labeling functions.

According to a further embodiment applying the labeling functions can comprise labeling of data points programmatically. Programmatically labeling of data points provides a simple and comfortable method for labeling data reducing human efforts on coding human knowledge into heuristics.

Within a further embodiment a matrix of labels of the labeled data can be generated based on the output of the labeling functions, wherein each row of the matrix can refer to a data point and each column can refer to an output of a particular labeling function. If a labeling function abstains from giving a label for a data point, no label is assigned at the respective position in the matrix. Based on such a matrix an efficient method can be provided.

According to a further embodiment the matrix can be amended and/or completed by—preferably adding—labels resulting from the predicting and/or generating step. As a result of such an amended and/or completed matrix more labels are available for providing a more efficient and performant method and system.

Within a further embodiment a component predicting and/or generating labels for abstains or abstain cases of labeling function outputs and/or not labeled or partially labeled data points under consideration of data point correlations and/or similarities can predict abstains or abstain cases in the matrix, wherein the component can be a generative machine learning, ML. Such a component can effectively provide a double function in predicting abstains or abstain cases and predicting and/or generating labels for not labeled or partially labeled data points. In other words, the component can predict a label using outputs that are predicted by itself.

According to a further embodiment abstains or abstain cases in the matrix can be replaced with certain values or values or labels resulting from the predicting and/or generating step, preferably by this component. This will simply amend and/or complete a matrix at abstains.

Within a further embodiment similarities between original data points can comprise distances or values of distances between original data points. This feature can result in a simplification and enhancement of effectiveness of the method, as handling of distances is easy and can result in various applications.

According to a further embodiment the amended and/or completed matrix is fed to a generative machine learning, ML, that chooses a single label for the data points or for any given data point. Such a generative machine learning can simply be a section or a part of the whole machine learning system.

In a further step and according to a further embodiment chosen single labels can be used for training a discriminative model. On the basis of the chosen single labels the discriminative model is able to converge easy for different tasks.

Within a further embodiment a heuristic method or a learning algorithm can implement a generative machine learning, ML, for reinforcing labels by a Labeling Functions' Reinforcer, wherein preferably the Labeling Functions' Reinforcer amends and/or completes the matrix before the generative model decides on the final array of labels in the matrix. Based on such a step of reinforcing labels the information contained in the original data points can be extracted much more effectively as in known methods. Thus, a much more effective method for operating a machine learning system can be provided.

According to a further embodiment in the heuristic method or learning algorithm and/or in the processing step a gravitation process or a clustering process can be used, wherein preferably the gravitation process and the clustering process are based on similarities between not labeled data points or abstains or abstain cases and labeled data points. Both, the gravitation process and the clustering process can contribute to increase effectiveness and performance of the method for operating a machine learning system in a simple way.

Within a further embodiment and depending on the individual application situation the data points can be vectors, texts or images.

According to a further embodiment the method can be very effectively used in Internet of Things, IoT, or in healthcare. However, much more applications of embodiments of the invention are possible in different technical fields.

Advantages and aspects of embodiments of the present invention are summarized as follows:

Embodiments propose a new and efficient system based on generative machine learning, Generative ML, for data programming and a method to implement this system called reinforced labeling functions, RLF. Embodiments of the proposed invention disclose a method to reinforce the existing labeling approach by taken into account the raw unlabeled data features early-on in the design of the ML system. As shown in embodiments, reinforced labeling can leverage machine learning for predicting labeling function, LF, outputs for the data points that are not previously labeled by the corresponding LFs. The basic intuition comprises learning the correlations between the heuristic outputs—LFs—as well as the distances or similarities between unlabeled—raw—data points in the generative process of the data programming. Given a set of LFs from a knowledge base and a set of raw data points, the system can substantially enhance the output prediction performances of the machine learning, while it also reduces the need for creating new heuristics. Similarly, the approach can leverage various more advanced machine learning approaches such as deep neural networks.

Embodiments of this invention disclose a system and a method to enhance weak supervision ML approaches, that are based on labeling datasets programmatically, e.g., through heuristics, resulting into improvements of ML tasks performances while reducing the need for creating new heuristics. The method can be based on learning the correlations between the heuristic outputs as well as the distances or similarities between unlabeled—raw—data points in a newly proposed generative ML process of the data programming.

Further embodiments propose a system to automatically increase the size of the set of labels generated by heuristics.

Further advantages and aspects of embodiments of the present invention are summarized as follows:

Embodiments of the invention can increase the size of the labeled dataset used for the training of the end discriminative model in weak supervision ML based on programmatic labeling by processing the output of the labeling functions in order to learn the correlations and similarities between data points labelled by the heuristics and unlabeled—raw—data points. This additional step predicts and generates new and/or latent labels for the data points that are not labeled by the labeling functions.

An embodiment of the invention can comprise the following steps:
1) Providing unlabeled input data with features and labeling functions from a knowledge base.
2) Applying labeling functions to the unlabeled data or dataset in order to compute a matrix of labels.
3) Adjusting the matrix of labels by applying the reinforced labeling component, LFsR, that computes on top of the labels matrix.
4) Feeding the LFsR output matrix and data features to the generative machine learning that choose a single label for any given data point.
5) Training the discriminative model for prediction of situations and deciding actuations.

Embodiments of the invention can minimize the costs to develop a machine learning application and reduce the number of labeling functions to be implemented by users or developers.

There are several ways how to design and further develop the teaching of the present invention in an advantageous way. To this end it is to be referred to the following explanation of examples of embodiments of the invention, illustrated by the drawing.

In classic data programming the set of labeling functions, LFs, annotates a portion of the original dataset D—comprising original data points—with a total labeling coverage of γ□ [0,1] of dataset D. A generative model takes as input the matrix from the LFs set, filters the data points with no label—all the LFs voted for abstains—and decides a final label for each labeled data point. An example of generative models might be a majority voter or a more sophisticated based on probabilistic means. A final end model, a discriminative model such as a neural network, uses the features of the labeled data points within the set D and the labels from the generative models to be trained.

In general, the bigger the labelled training data, the better trained results of the discriminative model. In data programming systems, we can say the bigger γ, the better the final prediction. This invention aims to increase the coverage γ given the same number of LFs or even the same set LFs. Therefore, this invention maximizes the accuracy of the ML pipeline while at the same time minimizes the costs of creating LFs by reducing the number of the LFs to be written.

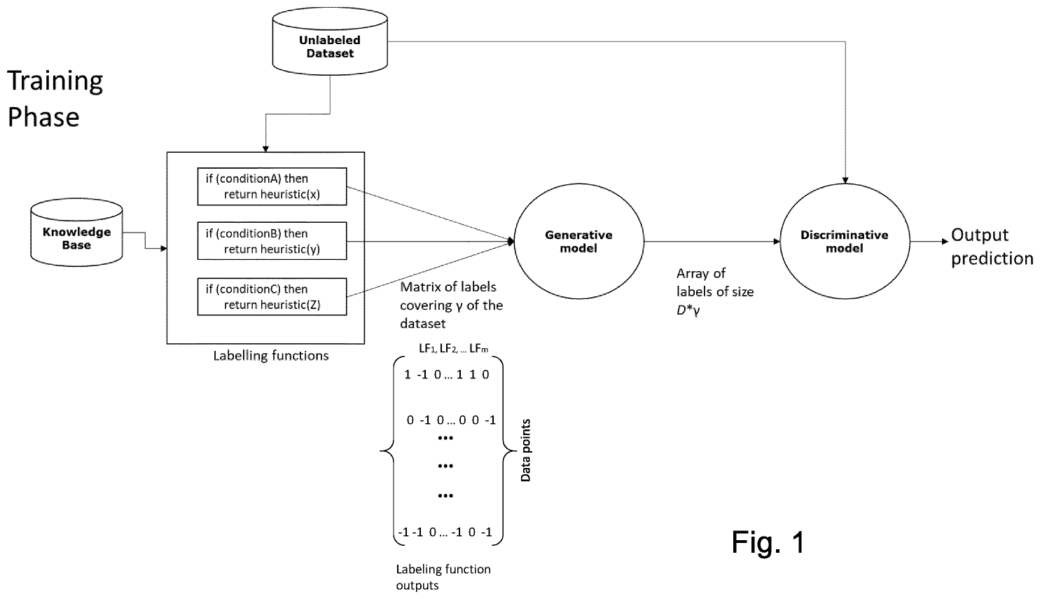

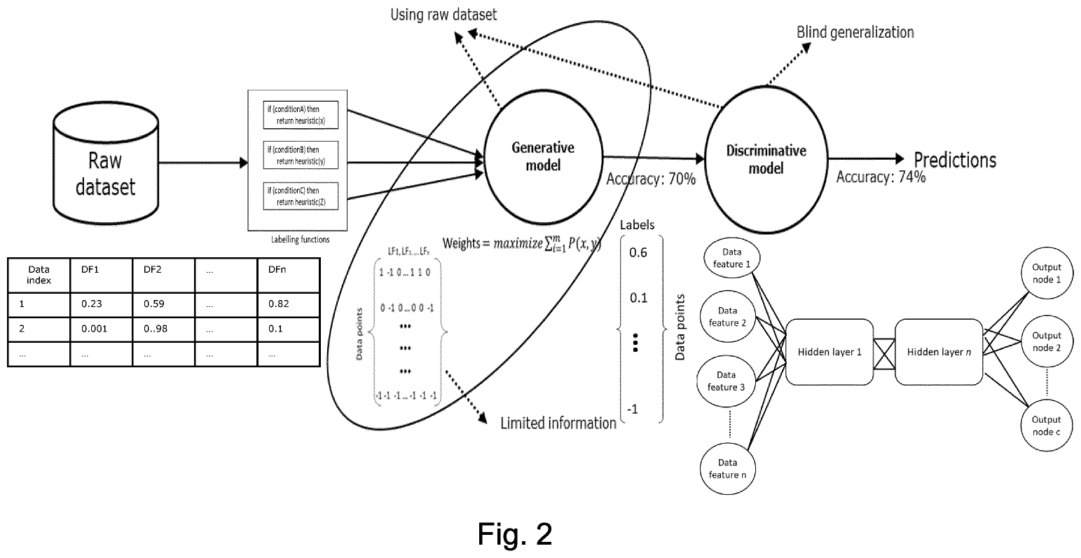

The design figure shared in FIG. 1 and FIG. 2 illustrates the existing data programming ML system design with its main flaws in terms of lack of good generalization—shown as “blind generalization” by an end model—as well as limitations of the data that is fed to the generative model—called the labeling matrix, that is the initial LF outputs on the unlabeled data.

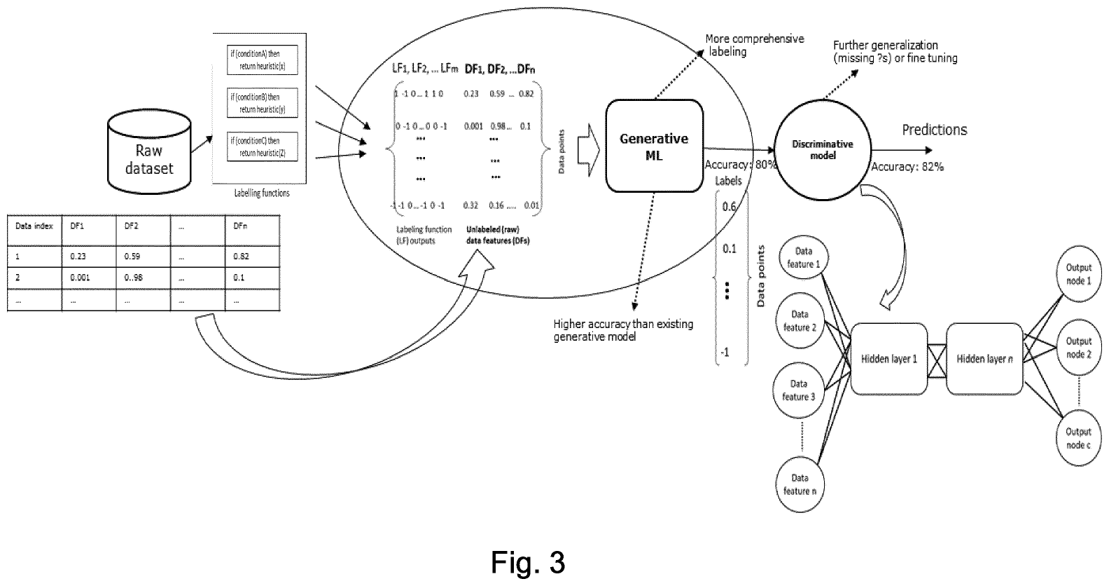

FIG. 3 illustrates the new design that leverages the unlabeled—raw—data features early on in the proposed ML pipeline. The new design is called the “generative machine learning for data programming”. The “Generative ML” module is the key differentiator component which can be implemented using different heuristics or learning algorithms for optimization and efficiency of the whole pipeline. The process can be considered as a way of “label augmentation”, which relies on augmenting the existing labels on the data. This approach is different than the existing “data augmentation” approaches that are focused on creating new data points, whereas the newly proposed method does not create any new data points, but rather augments labels and creates more through machine learning.

The outcome of the generative ML module is expected to be more useful than the existing generative model due to additional coverage and accuracy gains without any additional hand labeling or labeling functions. The −1s that represent in the LF side of the matrix shown in FIG. 3, left side of the matrix, can be predicted through the machine learning by “Generative ML” component. This component first predicts the abstains or abstain cases in the matrix and replaces them with certain values, e.g., prediction values between 0 and 1 for a binary classification task. Generative ML also predicts a label using the enhanced LF outputs that are predicted—reinforced—by itself. In embodiments of this invention is described one heuristic solution to implement a Generative ML, while this component can use different heuristics of ML approaches through an optimization loss function. The training data for training this ML would consist of the data features, DFs, in FIG. 3 for x values and the labeling function outputs that already exist—after simple application of LFs to the unlabeled data without any reinforcement. This way the unknown values in the matrix—−1s—would be predicted through machine learning.

In embodiments of this invention is described a heuristic method which implements the Generative ML for “reinforcing the labels”. The heuristic approach is called “reinforced labeling”. In embodiments this heuristic contains a few of algorithms such as the “gravitation approach” or “clustering approach”, whereas other possible algorithms can be proposed to implement reinforced labeling.

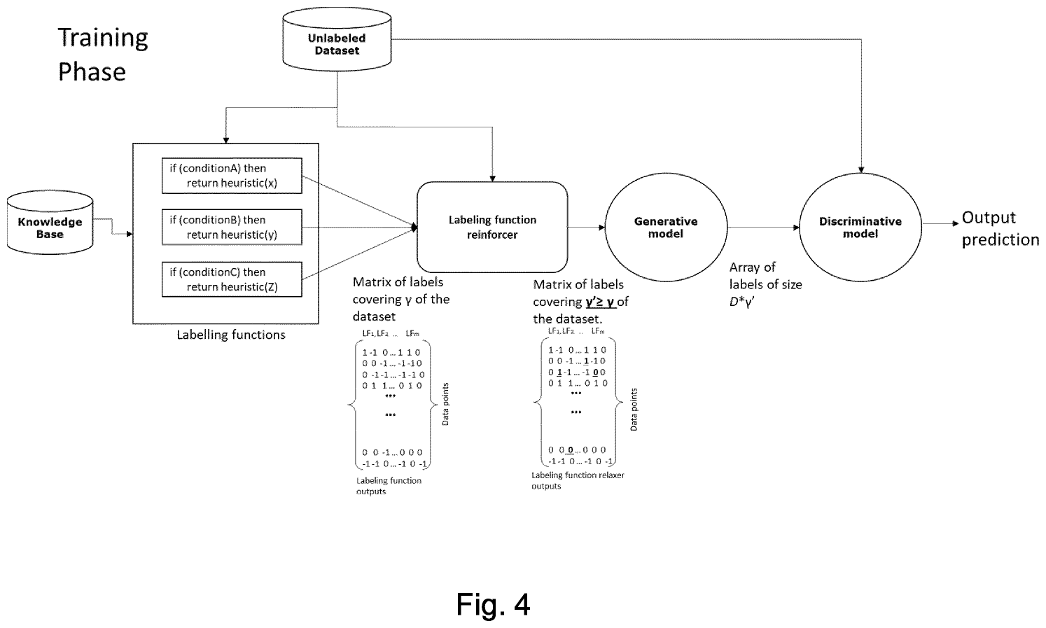

FIG. 4 illustrates an embodiment of the heuristic method for the proposed generative machine learning for a data programming approach. This embodiment method has a new component, namely the Labelling Functions' Reinforcer, LFsR, that adds changes of some of the values that represent abstains or abstain cases, e.g., −1 values, with labels before the generative model decides on the final array of labels. In this method, LFsR and the generative model together are considered for implementing the “Generative ML” component.

The intuition of embodiments of this method comes from the fact that some data points that are not labeled by the LFs might be close to the others that are labeled by LFs through the matching of the conditions in the LFs. The LFsR reinforces the labeling by also predicting labels for these previously unlabeled data and therefore produces a higher coverage γ′≥γ, thus to have a bigger dataset for the training of the discriminative end model.

The reinforcement process reduces the costs of fine tuning the heuristics or writing more heuristics to improve the coverage of the unlabeled dataset. Similarly, the system's discriminative model is able to converge easier for different tasks even if the model is initialized with exactly the same hyperparameter set and values.

Assume that we have an unlabeled dataset D with n unlabeled data points. A knowledge base includes a set Δ of m labelling functions, LFs. Each LF λᵢ∈Δ is a heuristic labeling a subset of the dataset. In this invention, the LFsR component targets to use the same labeling functions, LFs, but creates a different matrix M′ with a different coverage γ′ that is always more than or equal to γ. The LFsR component changes some of the abstain values to prediction labels of the tasks, e.g., 1 or 0 for binary tasks. The LFsR goes over every point pᵢⱼ in the matrix M that represents abstain or abstain case, e.g., −1, as a result of a data point xⱼ and labeling function λⱼ, and compares the correlations/similarities of xⱼ with x's in the data set that are labeled by λᵢ as well as their labeling outputs. The intuition follows that, learning from these correlations, LFsR can identify the unlabeled data points that are similar to the others which are labeled and labels those points too.

Slightly different than the above intuition, instead of the data points x's, labeling matrix points pᵢⱼ's representing abstains or abstain cases are identified in such fashion by LFsR. For this identification, similarities of the data point x's are leveraged. Leveraging this additional information that was previously not used by the LFs brings additional generalization gains—other than the gains that are supposed to come from the discriminative model—that in certain scenarios would provide a highly effective solution for higher prediction accuracy—e.g., classification accuracy, F1, recall—and having the need for a smaller number of LFs in the knowledge base. These are considered the main advantages of the proposed system.

One embodiment of the LFsR may follow a gravitation approach. Another embodiment may follow a clustering approach.

Both of these so-called gravitation and cluster approaches are based on the similarities of each point pᵢⱼ that corresponds to xⱼ and all Xᵢ that represent the set of data points which are labeled by the LF λᵢ. This is considered for all pᵢⱼ that are a result of an abstain or abstain case by λᵢ.

In one embodiment, data points are vectors of numbers of the size of the features set. In other embodiments, data points are texts. In some other embodiments, data points are images.

### Gravitation Approach

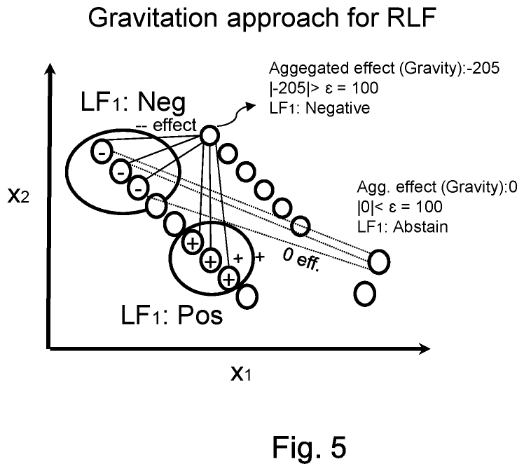

In the gravitation approach embodiment illustrated in FIG. 5, given an abstain point—particle—pᵢⱼ, and considering all other points in the same column of pᵢⱼ which are labeled by λᵢ with any class other than abstain, each other point is considered as a particle that would attract pᵢⱼ. The attraction is disproportional to the pairwise distance of every particle to the particle pᵢⱼ. An aggregated effect—gravitational force—is calculated for pᵢⱼ by all other points. The total effect can be compared against a threshold ε. If the aggregated effect—gravity—is more towards a certain class and if it is with more than ε, pᵢⱼ would be labeled by that class.

The threshold ε can a static or dynamically set parameter. If ε=0, the resulting labeling matrix may have no abstains or abstain cases. In case there is no LF that labels no data point and if the gravities do not combine to a total aggregated value of 0, this would be the case for any pᵢⱼ.

A possible additional parameter can be a distance threshold ε_{d}. If this parameter is added to the model, the gravitation between any pair xᵢ and xⱼ would not be computed, if the distance between the two data points Distance(xᵢ, xⱼ)>ε_{d}.

Different possibilities can be considered for the distance function Distance(xᵢ, xⱼ). For sensor data with continuous variables such as real numbers, mahalanobis distance can be used. Similarly, Euclidean distance, Jaccard distance, or cosine distance can be applied to compute distance. In other embodiments, where data points are texts, distance might be hamming distance, Levenshtein distance, or cosine distance. In some other embodiments, where data points are images, the distance might be the Minkowski distance, the Manhattan distance, the Euclidean distance and the Hausdorff distance.

The gravity effect of each labeled particle can be calculated based on the distance. The effect value is proportional to

$$\frac{β}{{Distance ( {x}_{i} , {x}_{j} )}^{α}} ,$$

where α and β would be constant parameters.

### Clustering Approach

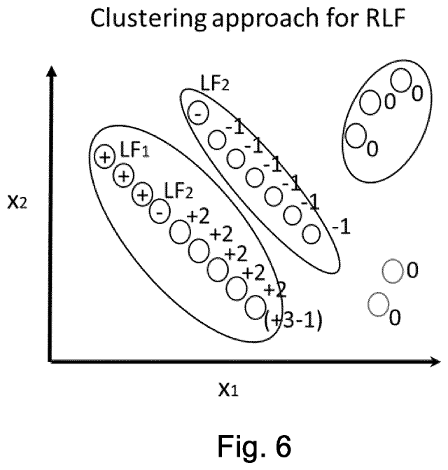

In the clustering approach embodiment illustrated in FIG. 6, given an abstain point—particle—pᵢⱼ, and considering all other points in the same column of pᵢⱼ that are labeled by λᵢ with any class other than abstain, each other point is considered if they are in the same cluster with xⱼ and they are not considered if they are in different cluster with xⱼ.

As a first step of this approach, all the data points in the unlabeled dataset are clustered using a clustering approach such as the k-nearest neighbor, KNN, algorithm. After clustering, a similar iteration, as described in the above approach, over all abstains or abstain cases in the labeling matrix is performed. For every abstain point pᵢⱼ, every other point in the same column which is not abstained by λᵢ and which is included in the same cluster is considered as “effect”. An effect can be represented by a simple value such as “+1” or “−1” by every such data point. As an approach with more complexity, distance or other factors might be also considered to compute this “effect”, whereas for simplicity FIG. 4 illustrates +1 for each effect, meaning a data point with a label—marked class—by λᵢ having an effect of +1 or −1, considering the simple case of binary classification and the simple approach of having effect without any additional factor than being in the same cluster. All such points are considered and their effects are aggregated for the data point xⱼ.

Similar to the gravity approach, the total effect can be compared against a threshold ε. If the aggregated effect is more towards a certain class and if it is with more than ε, pᵢⱼ would be labeled by that class.

For the initial clustering step, various clustering algorithms such as k-means, hierarchical clustering or density-based spatial clustering, DBSCAN, can be used. In algorithms such as DBSCAN, some data points—either a data point that is labeled or unlabeled—can be outside of the clusters and marked as “noise points”.

### Guided LFS Reinforcer

In some embodiments there might be a very small labeled dataset G of size orders of magnitude smaller than the size of unlabeled dataset D.

The small labeled dataset G is used to guide the generation of the gravity influences of the areas, in case of gravity approach, or to influence the assignments of class to the K clusters of KNN.

### Industrial IOT Use Case

In industrial IoT, IIoT, also known as smart industry or Industrie 4.0, sensors and devices are continuously measuring the behavior of machineries in industrial plants. The sensed information is useful to infer situations of the production processes to automatically command the machines for efficient and safe operations. In the past, situations were detected through the execution of complex functions and simulation models based on physics laws. However, new situations to be detected may require new complex heuristics to be developed.

Using machine learning, ML, for these scenarios might save time and effort to engineers to build up automation systems. Nevertheless, traditional supervised machine learning may require big amount of data correctly labeled by a domain expert, e.g., machine engineer, to be used for training a ML model classifier. Data programming, a weak supervision approach, instead, may require a set of heuristics, implemented by a domain expert, to programmatically label the data.

With normal data programming, the quality and the amount of those heuristics are important. This invention allows to have less heuristics to be developed to achieve same or better results than normal data programming. The heuristics needed are not necessary advanced heuristics such as the one used nowadays for deterministic automation, but they might be simple, as, for instance, a threshold. These translate in less time than spent by domain experts, e.g., machine engineers, resulting in less costs.

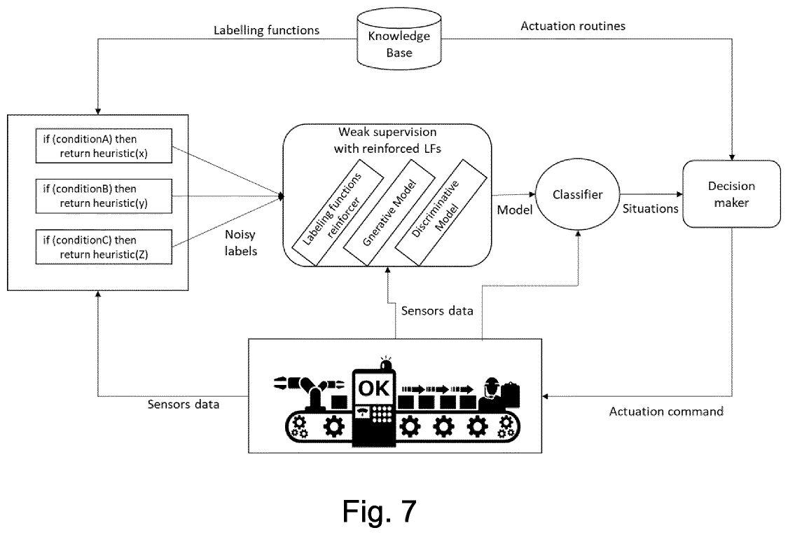

FIG. 7 shows a full system that uses this invention in a smart plant scenario. Sensor data are produced by sensors and devices in the industrial plant. Heuristics generate the first initial noisy labels, and the weak supervision with reinforced LFs uses the sensor data to enhance and augment the noisy labels. Out of this process, a classifier is trained and used to infer situations in the plant. Such situations are used by a decision maker component to choose actuation routines from a knowledge base and actuate them in the plant, e.g., decrease temperature in some chemical machines, command a robot arm to move an object.

### Healthcare Use Case

In healthcare many vital signals of a human are measured with different means such as wearable sensors or clinical examinations. There can be dozens or hundreds of valueds for a single patient. Implementing a machine learning classifier to infer the health status of a patient might be very expensive if adopting a classic supervised learning approach, due to the labeling of a big enough dataset by domain experts, i.e., doctors.

Data programming foresees the doctors to define heuristics that programmatically annotate roughly data. However, writing good enough labeling functions for an acceptable end-model is still a challenge. This invention minimize the costs of writing labeling functions by maximizing LFs applications even when not directly specified by the domain experts. Thus, the costs for developing of a healthcare solution would decrease significantly using the proposed ML system.

A healthcare application might foresee automatic adjustment of medical treatment based on the information given through sensed vital signs. For example, when it is predicted that a patient is going to have a lower amount of oxygen in the blood, a self-adjusting ventilator might start to increase the oxygen flow into the patient while the medical staff is being alerted.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for operating a machine learning (ML) system by means of a data processing system, wherein original data points of a data set are labeled by the data processing system, the method comprising:
providing the data set and a set of labeling functions for the original data points;
applying the labeling functions to the original data points for providing a corresponding output of the labeling functions, the output comprising labeled data points and labeling function outputs corresponding to each data point;
processing at least a part of the output for learning correlations and/or similarities between labeled data points and original data points; and
predicting and/or generating labels for abstains or abstain cases of labeling function outputs under consideration of data point correlations and/or similarities.

2: The method according to claim 1, wherein the data set and the set of labeling functions are provided in a knowledge base.

3: The method according to claim 1, wherein applying the labeling functions comprises labeling of data points programmatically.

4: The method according to claim 1, wherein a matrix of labels of labeled data is generated based on the output of the labeling functions.

5: The method according to claim 4, wherein the matrix is amended and/or completed by adding labels resulting from the predicting and/or generating step.

6: The method according to claim 4, wherein a component predicting and/or generating labels for abstains or abstain cases of labeling function outputs under consideration of data point correlations and/or similarities predicts abstains or abstain cases in the matrix, wherein the component is a generative machine learning; (ML).

7: The method according to claim 6, wherein abstains or abstain cases in the matrix are replaced with certain values or labels resulting from the predicting and/or generating step by the component.

8: The method according to claim 1, wherein similarities between original data points comprise distances or values of distances between original data points.

9: The method according to claim 5, wherein the amended and/or completed matrix is fed to a generative machine learning (ML) that chooses a single label for the data points or for any given data point.

10: The method according to claim 1, wherein chosen single labels are used for training a discriminative model.

11: The method according to claim 4, wherein a heuristic method or a learning algorithm implements a generative machine learning (ML) for reinforcing labels by a Labeling Functions' Reinforcer, wherein the Labeling Functions' Reinforcer amends and/or completes the matrix before the generative model decides on the final array of labels in the matrix.

12: The method according to claim 11, wherein in the heuristic method or learning algorithm and/or in the processing step a gravitation process or a clustering process is used, wherein the gravitation process and the clustering process are based on similarities between not labeled data points or abstains or abstain cases and labeled data points.

13: The method according to claim 1, wherein the data points are vectors, texts or images.

14: The method according to claim 1, wherein the method is used in Internet of Things (IoT) or in healthcare.

15: A data processing system for carrying out the method for operating a machine learning (ML), wherein original data points of a data set are labeled by the data processing system, the system comprising:
providing means for providing the data set and a set of labeling functions for the original data points;
applying means for applying the labeling functions to the original data points for providing a corresponding output of the labeling functions, the output comprising labeled data points and labeling function outputs corresponding to each data point;
processing means for processing at least a part of the output for learning correlations and/or similarities between labeled data points and original data points; and
predicting and/or generating means for predicting and/or generating labels for abstains or abstain cases of labeling function outputs under consideration of data point correlations and/or similarities.
